(19) United States
(12) Patent Application Publication
(10) Pub. No.: US 2019/0303517 A1
(43) Pub. Date: Oct. 3, 2019

(54) SIMULATION DEVICE

(71) Applicant: FANUC CORPORATION, Yamanashi (JP)

(72) Inventor: Norihiko ZAIMA, Yamanashi (JP)

(21) Appl. No.: 16/364,746

(22) Filed: Mar. 26, 2019

(30) Foreign Application Priority Data
Mar. 29, 2018 (JP) 2018-065522

(51) Int. Cl. G06F 17/50; G05B 19/4099

(52) U.S. Cl. CPC G06F 17/5009; G05B 2219/35009; G05B 2219/35097; G05B 19/4099

(57) ABSTRACT

A simulation device includes a simulation unit that generates a machining path on the basis of a machining program that specifies information on the shape of a workpiece and information on the shape of a tool to simulate a machined shape of the workpiece including a plurality of machined surface areas that are machined by the tool; an associated information storage unit that stores, in association with each other, machined surface identification information that can identify each of the plurality of machined surface areas, and block identification information that identifies blocks in a program that machine each of the plurality of machined surface areas; a machined surface selection unit that can select a specific machined surface area; and a block identification information acquisition unit that acquires the block identification information stored in association with the machined surface identification information that identifies the selected machined surface area.

This application is based on and claims the benefit of priority from Japanese Patent Application No. 2018-065522, filed on 29 Mar. 2018, the content of which is incorporated herein by reference.

### BACKGROUND OF THE INVENTION

### Field of the Invention

The present invention relates to a simulation device.

### Related Art

A traditional NC machining apparatus is configured to perform a machining operation according to a certain machining program. Before the NC machining apparatus actually performs the machining operation, the machining program must be pre-examined to confirm if the machining operation will operate correctly.

Generally speaking, simulation based on the machining program is performed using a simulation device to confirm the machining operation. For example, a machining trajectory is displayed on a display screen to check whether the machining operation will operate correctly. If any editing is required, the block in the machining program that requires editing is identified and the program is edited as necessary.

Details and results of the simulation are preferably confirmed in a state in which the block that causes problems in the machining program can be easily identified. However, identifying the block in the machining program that causes problems is usually a difficult task. For example, if attempting to identify a problem block from a drawing of a machining path, it is difficult to determine which line segment is causing the problem because the machining path is made up of a large number of line segments.

In order to deal with this problem, there has been proposed a simulation device that can display blocks that make up a machining cycle command in synchronization with a moving image of a machining operation (see, for example, Patent Document 1).

Patent Document 1: Japanese Unexamined Patent Application, Publication No. 2014-16982

### SUMMARY OF THE INVENTION

However, with the simulation device disclosed in Patent Document 1, in order to identify a block in a machining program that corresponds to, for example, a machined surface that has been erroneously cut, it is only possible to confirm the corresponding block by confirming the machined surface that has been erroneously cut using the moving image.

In addition, with the simulation device disclosed in Patent Document 1, even if the erroneously cut machined surface is known, the user has to check the moving image in order to identify the block in the program that corresponds to the surface, and this takes time. As such, there is a problem in that it is difficult to identify the block in the program that corresponds to the erroneously cut machined surface, even if the machined surface has been identified.

The present invention has been made in light of the aforementioned circumstances, and it is an object of the present invention to provide a simulation device with which it is possible to check a block in a machining program that corresponds to a specific machined surface area.

(1) The present invention provides a simulation device including: a simulation unit (for example, a simulation unit 11 to be described later) that generates a machining path for a tool (for example, a tool K to be described later) on the basis of a machining program that specifies information on the shape of a workpiece and information on the shape of a tool to simulate a machined shape of a workpiece (for example, a workpiece W to be described later) including a plurality of machined surface areas that are machined by the tool; an associated information storage unit (for example, an associated information storage unit 22 to be described later) that stores, in association with each other, machined surface identification information that can identify each of the plurality of machined surface areas in the machined shape of the workpiece simulated by the simulation unit, and block identification information that identifies blocks in a program that machine each of the plurality of machined surface areas; a machined surface selection unit (for example, a machined surface selection unit 14 to be described later) that can select a specific machined surface area among the plurality of machined surface areas; and a block identification information acquisition unit (for example, a block identification information acquisition unit 15 to be described later) that acquires from the associated information storage unit, when a specific machined surface area is selected by the machined surface selection unit, the block identification information stored in association with the machined surface identification information that identifies the selected machined surface area.

(2) In the simulation device according to (1), the simulation unit defines a specific machined surface area among the plurality of machined surface areas using a plurality of patches; the associated information storage unit stores, in association with each other, patch identification information that identifies the patches that define the specific machined surface area and the block identification information on the machining program that machines a portion corresponding to the patches; the machined surface selection unit can select the patches as the machined surface area; and the block identification information acquisition unit acquires from the associated information storage unit, when a specific patch is selected by the machined surface selection unit, the block identification information stored in association with the patch identification information that identifies the selected patches.

(3) The simulation device according to (1) or (2) further includes a machining program storage unit (for example, a machining program storage unit 21 to be described later) that stores the machining program containing the plurality of blocks; a display control unit (for example, a display control unit 13 to be described later) that generates a model image of the machined shape of the workpiece including the plurality of machined surface areas simulated by the simulation unit; and a display unit (for example, a display unit 30 to be described later) that can display the model image generated by the display control unit, in which the machined surface selection unit may be configured to be able to select a specific machined surface area on the basis of the model image (for example, a model image WM to be described later) displayed on the display unit, the block identification information acquisition unit may be able to acquire the block identification information from the associated information storage unit and acquire program content of a block identified using the block identification information from the machining program storage unit, and the display control unit may display on the display unit, when a specific machined surface area is selected by the machined surface selection unit, the model image of the machined shape of the workpiece including the selected machined surface area, and the program content of the block acquired by the block identification information acquisition unit.

According to the present invention, there can be provided a simulation device with which it is possible to check a block in a machining program that corresponds to a specific machined surface area.

### BRIEF DESCRIPTION OF THE DRAWINGS

FIG. 1 is a block diagram for illustrating a configuration of a simulation device according to an embodiment of the present invention.

FIG. 2 is a diagram for illustrating content displayed on a display unit of the simulation device according to the embodiment of the present invention.

FIG. 3A is a diagram for explaining an outline of a machining operation and patch generation and shows a state in which a tool is machining workpiece.

FIG. 3B is a diagram for explaining an outline of a machining operation and patch generation and shows a state in which a machined surface has been machined by the tool.

FIG. 3C is a diagram for explaining an outline of a machining operation and patch generation and shows a state in which new patches have been generated on the machined surface.

FIG. 4 is a flowchart for illustrating operation of the simulation device during machining simulation.

FIG. 5 is a flowchart for illustrating operation of the simulation device when editing a block in a machining program corresponding to a specific machined surface.

### DETAILED DESCRIPTION OF THE INVENTION

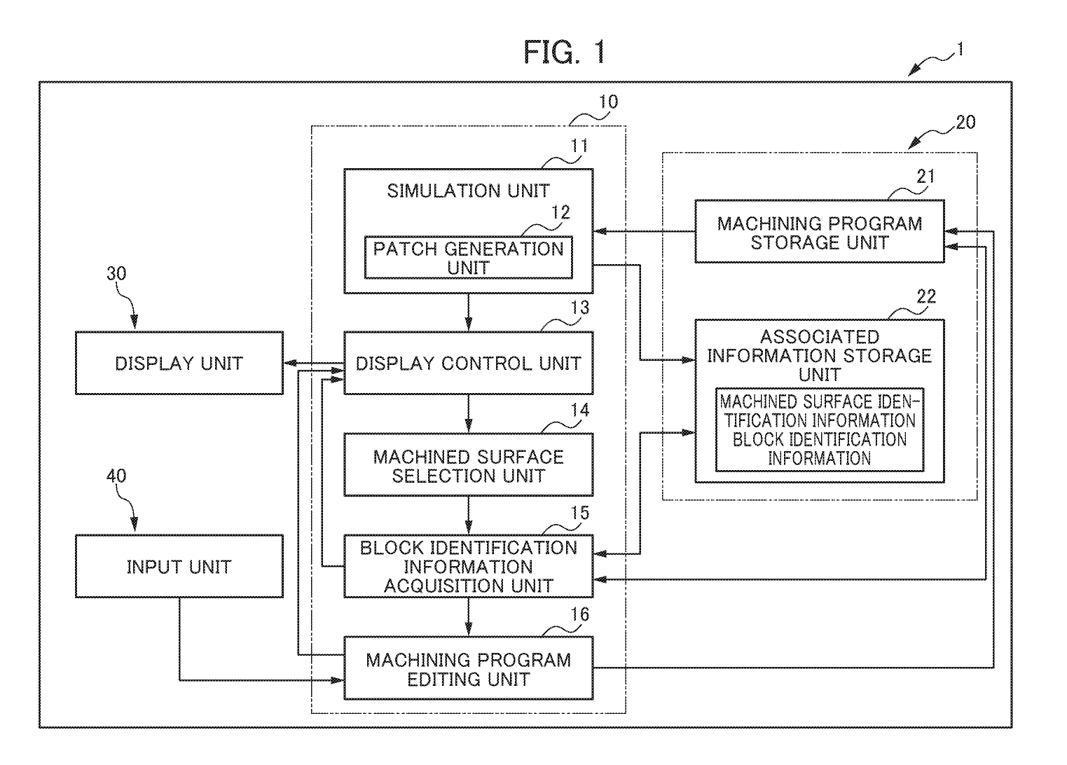

An embodiment of the present invention is described below in detail with reference to FIGS. 1 to 5.

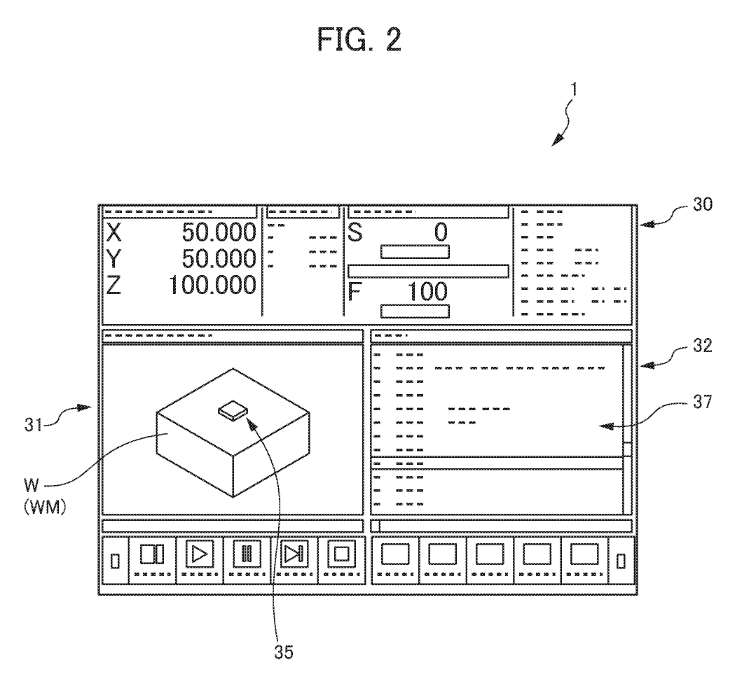

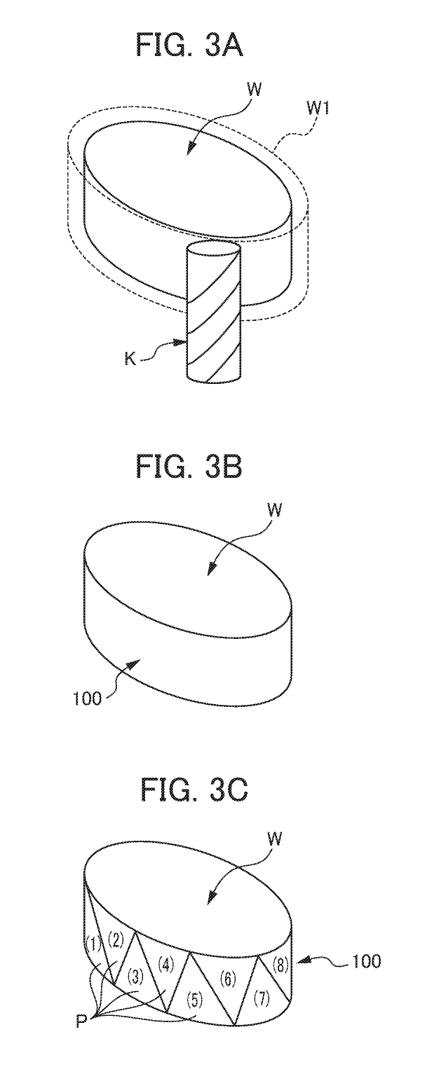

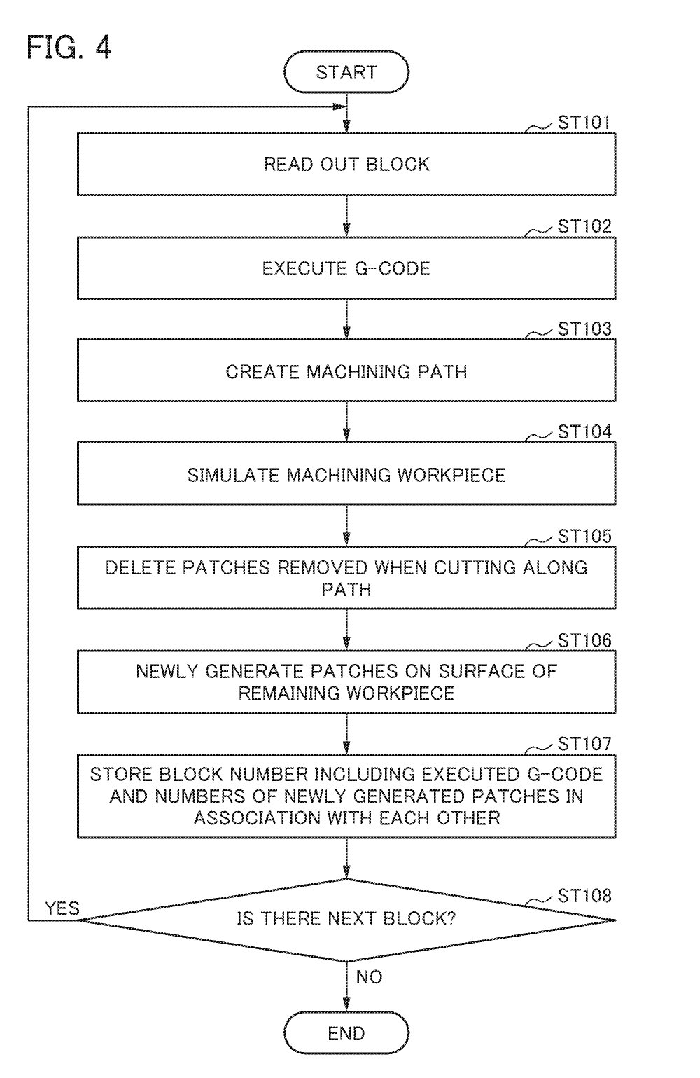

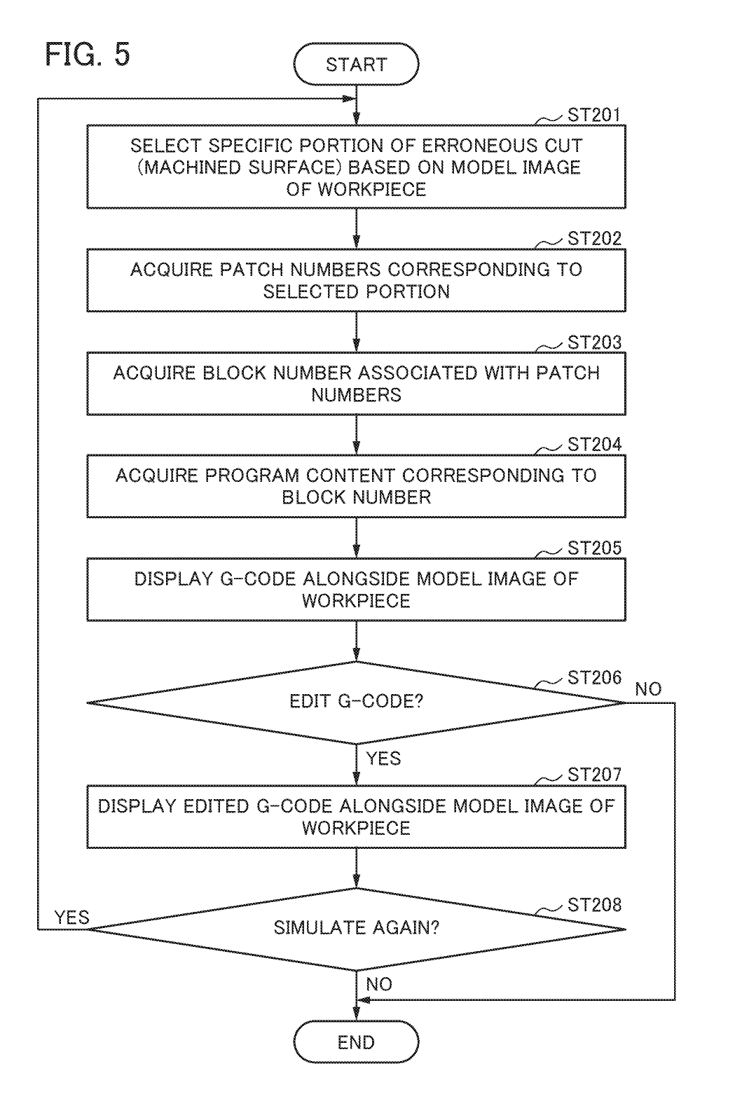

FIG. 1 is a block diagram for illustrating a configuration of a simulation device according to the embodiment of the present invention. FIG. 2 is a diagram for illustrating exemplary content displayed on a display unit according to the embodiment of the present invention. FIGS. 3A to 3C are diagrams for explaining an outline of a machining operation and patch generation, with FIG. 3A showing a state in which a tool is machining workpiece, FIG. 3B showing a state in which a machined surface has been machined by the tool, and FIG. 3C showing a state in which new patches have been generated on the machined surface. FIG. 4 is a flowchart for illustrating operation of the simulation device during machining simulation. FIG. 5 is a flowchart for illustrating operation of the simulation device when editing a block in a machining program corresponding to a specific machined surface.

The simulation device according to this embodiment consists of a processing unit such as a computer that has a CPU, a ROM, a RAM and other such components. The simulation device according to this embodiment may be configured integrally with a numerical control device, or may be another computer such as a host control device separate to a numerical control device.

As illustrated in FIG. 1, a simulation device 1 includes a control unit 10, a storage unit 20, display unit 30 and an input unit 40.

As illustrated in FIG. 1, the control unit 10 includes a simulation unit 11, a display control unit 13, a machined surface selection unit 14, block identification information acquisition unit 15 and a machining program editing unit 16.

The simulation unit 11 creates a machining path for a tool on the basis of a machining program that specifies information on the shape of a workpiece and information on the shape of the tool, to thereby simulate the machined shape of the workpiece, including a plurality of machined surface areas that are machined by the tool. The information on the shape of the workpiece is, for example, initial 3D shape information of a workpiece W that is to be machined. Similar to the information on the shape of the workpiece, the information on the shape of the tool is, for example, 3D shape information (also includes information on diameter, for instance) on the tool that is used for machining.

The machining program is a program that defines the operation of a machining apparatus and is made up of a plurality of blocks. Each block includes block identification information that identifies the block. The block identification information is not particularly limited provided that the block can be identified and may be, for example, a block number, a sequence number or notation information. In this embodiment, a block number is often used as an example of the block identification information.

The simulation unit 11 creates a machining path for the tool. The machining path is a movement path at a predetermined position (for example, a center point) of the tool. The simulation device 1 according to this embodiment can simulate the machined shape of the workpiece including a plurality of machined surfaces (machined surface areas) after machining on the basis of the information on the shape of the tool. The simulation unit 11 simulates the machined shape of the workpiece including the plurality of machined surface areas machined by the tool.

Machined surface identification information that identifies each of the plurality of machined surfaces simulated by the simulation unit 11 is stored in an associated information storage unit 22 (described later) in association with the block identification information that identifies the blocks (part of the machining program) that machine the plurality of machined surface areas. One machined surface area can be defined as, for example, ranges machined by the same block (program). A model image of the shape of the machined workpiece simulated by the simulation unit 11 is displayed on the display unit 30 using the display control unit 13 (described later).

The simulation unit 11 includes a patch generation unit 12. The patch generation unit 12 defines a specific machined surface among the plurality of machined surfaces (machined surface areas) using a plurality of patches. The patch generation unit 12 generates the plurality of patches on a surface of the workpiece W to be machined (often a machined surface after machining) as a reference for the machining operation.

For example, as illustrated in FIGS. 3A to 3C, the patch generation unit 12 mainly generates the plurality of patches (for example, triangle patches) on a curved machined surface. More specifically, the simulation device 1 simulates cutting workpiece (see FIG. 3A) achieved by moving the tool K along the machining path, to thereby simulate the shape of the workpiece (see FIG. 3B). The workpiece has a machined surface 100. Then, the patch generation unit 12 generates a plurality of triangle patches P on the curved machined surface 100 formed through cutting machining using the tool K. The patch generation unit 12 assigns a patch number (patch identification information) to each of the generated patches P such that the patches P can be identified. The patch identification information that identifies the patches P is not limited to a patch number or a number (numerical digit) provided that the patches P can be identified and may be a character string, a symbol or a name.

The patches P generated by the patch generation unit 12 are to be selected by the machined surface selection unit 14 (described later) along with the machined surface (machined surface area). In addition, the patch number as the patch identification information that identifies the patch P is machined surface identification information that identifies a machined surface. The patch number is stored in the associated information storage unit 22 (described later) in association with the block (part of the machining program) that machines the machined surface including the patches P.

The display control unit 13 generates a model image WM of the machined shape of the workpiece W including the plurality of machined surface areas simulated by the simulation unit 11. Then, the display control unit 13 displays the model image WM of the machined shape of the workpiece W on the display unit 30. In addition, the display control unit 13 displays the model image WM of the machined shape of the workpiece W and the block in the machining program that corresponds to that particular machined surface side-by-side on the display unit 30 (see FIG. 2).

More specifically, if a certain machined surface area (for example, a machined surface 35 (see FIG. 2)) is selected by the machined surface selection unit 14, the display control unit 13 displays the model image WM of the machined shape of the workpiece W including the selected machined surface 35 and the program content of block acquired by the block identification information acquisition unit 15 (described later) side-by-side on the display unit 30. In terms of actual operation, the display control unit 13 displays the model image WM of the machined shape of the workpiece W on the display unit 30. Then, when the specific machined surface 35 in the displayed model image WM is selected by the machined surface selection unit 14, the display control unit 13 displays program content of the block associated with the machined surface 35 (machined surface identification information) acquired by the block identification information acquisition unit 15 on the display unit 30 alongside the model image WM.

The display control unit 13 can also highlight the machined surface area selected by the machined surface selection unit 14. The display control unit 13 can display the model image WM and the program content of the block side-by-side and further display this information in various different ways to show the association between the model image WM and the program content.

The machined surface selection unit 14 can select a specific machined surface area from among the plurality of machined surface areas. For example, the machined surface selection unit 14 can select a specific machined surface area on the basis of the model image WM displayed on the display unit 30. If, for example, the specific machined surface 35 in the model image WM displayed on the display unit 30 is clicked using a mouse or touched via a touchscreen, the machined surface selection unit 14 is configured to select the machined surface 35. The machined surface selection unit 14 can output the machined surface identification information that identifies the selected machined surface 35 to the block identification information acquisition unit 15.

In addition, the machined surface selection unit 14 can select the patches P as the machined surface area. The machined surface selection unit 14 may be configured to select individual patches P or, if specific patches P are selected, select an entire machined surface machined on the basis of the same blocks (parts of the machining program). The machined surface selection unit 14 can output the patch numbers that identify the selected patches P to the block identification information acquisition unit 15.

The machined surface selection unit 14 may be configured to select a plurality of machined surface areas. In this case, the display unit 30 displays, for example, the model image WM with the plurality of machined surface areas highlighted and the plurality of blocks (parts of the machining program) associated with each machined surface areas side-by-side.

The machined surface selection unit 14 may be configured to automatically detect and select an erroneous surface (portion) that has been erroneously cut or the like. For example, the machined surface selection unit 14 may be configured to automatically detect and select the erroneous surface that has been erroneously cut by comparing the machined surface to statistical data on the shape of the workpiece. In this embodiment, “erroneously cut” refers to, for example, a workpiece being overly or insufficiently cut by the tool, interference between the tool and the workpiece, or interference between the tool and a jig that supports the workpiece.

When a specific machined surface area is selected by the machined surface selection unit 14, the block identification information acquisition unit 15 acquires the block identification information stored in association with the machined surface identification information that identifies the selected machined surface area from the associated information storage unit 22. The block identification information acquisition unit 15 can output the acquired block identification information to the display control unit 13.

When a specific patch P is selected by the machined surface selection unit 14, the block identification information acquisition unit 15 acquires the block identification information stored in association with the patch identification information that identifies the selected patch P from the associated information storage unit 22. In a similar manner, the block identification information acquisition unit 15 can output the acquired block identification information to the display control unit 13.

The block identification information acquisition unit 15 can acquire the block identification information from the associated information storage unit 22 and acquire the program content of the block identified using the block identification information from a machining program storage unit 21. The block identification information acquisition unit 15 can output the program content of the block identified using the acquired block identification information to the display control unit 13.

A machining program editing unit 16 can edit the program content of the block (part of the machining program) that machines the erroneous surface that has been erroneously cut. For example, when the program content of the block displayed by the display unit 30 is edited using the input unit 40, the machining program editing unit 16 can reflect the edited content in the program content of the block. The machining program editing unit 16 may be configured to select whether or not to reflect the edited content after the simulation unit 11 simulates edited machining program content after the edit.

Next, as illustrated in FIG. 1, the storage unit 20 includes the machining program storage unit 21 and the associated information storage unit 22.

The machining program storage unit 21 stores a machining program that contains a plurality of blocks. The machining program storage unit 21 stores a machining program that specifies information on the shape of the workpiece and information on the shape of the tool. The information on the shape of the workpiece and the information on the shape of the tool may be initially included in the machining program or, for example, may be input by a condition input unit (not shown). In addition, the machining program storage unit 21 stores the machining program so as to allow the machining program to be edited by the machining program editing unit 16.

The associated information storage unit 22 stores, in association with each other, machined surface identification information that can identify each of a plurality of machined surface areas in the machined shape of the workpiece W simulated by the simulation unit 11 and block identification information (for example, program numbers) that identifies blocks of the program that machines the plurality of machined surface areas. For example, the associated information storage unit 22 is configured to search and extract the block identification information (block numbers) stored in association with the machined surface identification information on the basis of the machined surface identification information.

In a similar manner, the associated information storage unit 22 stores patch identification information (patch numbers) that identify the patches P that define a specific machined surface area and the block identification information on the machining program that machines the portion corresponding to the patches P. The patch identification information and the block identification information are stored in association with each other. For example, as described above, the associated information storage unit 22 can search and extract the block identification information (block numbers) stored in association with the patch identification information on the basis of the patch identification information.

The display unit 30 can display the model image WM generated by the display control unit 13. The display unit 30 displays the model image WM of the machined shape of the workpiece W and the block of the machining program that corresponds to a specific machined surface side-by-side (see FIG. 2). More specifically, as illustrated in FIG. 2, the display unit 30 displays, for example, the model image WM of the machined shape of the workpiece W in a first display area 31 and displays program content 37 of the block in a second display area 32 next to the first display area 31. The display unit 30 includes, for example, various monitors or a touchscreen.

More specifically, when a specific machined surface area (for example, the machined surface 35 (see FIG. 2)) is selected by the machined surface selection unit 14, the display unit 30 displays the model image WM of the machined shape of the workpiece W that includes the selected machined surface 35 and the program content of the block acquired by the block identification information acquisition unit 15 (described later) alongside each other. In terms of actual operation, the display unit 30 displays the model image WM of the machined shape of the workpiece W and, if the specific machined surface 35 in the displayed model image WM is selected by the machined surface selection unit 14, displays the program content of the block associated with the machined surface 35 (machined surface identification information) acquired by the block identification information acquisition unit 15 alongside the model image WM.

The display unit 30 can highlight the machined surface area selected by the machined surface selection unit 14. The display unit 30 can display the model image WM and the program content of the block side-by-side and further display this information in various different ways to show the association between the model image WM and the program content.

Next, the input unit 40 can input content for editing the program content of the block displayed on the display unit 30. In addition, the input unit 40 can input commands for each control unit. A user can use the input unit 40 to input specific commands to each control unit by clicking various icons displayed on the display unit 30. The input unit 40 includes, for example, a touchscreen, a keyboard and a mouse.

Next, operation of the simulation device during machining simulation is described with reference to FIG. 4.

First, in Step ST101, the simulation device 1 (simulation unit 11) reads out each block that makes up the machining program from the machining program storage unit 21.

Then, in Step ST102, the simulation device 1 (simulation unit 11) executes (simulates) the G-code included in the blocks.

Next, in Step ST103, the simulation device 1 (simulation unit 11) simulates a movement path (machining path) of the tool K.

Then, in Step ST104, the simulation device 1 (simulation unit 11) simulates machining a workpiece on the basis of information on the shape of the workpiece, information on the shape of the tool and information on the machining path.

Next, in Step ST105, the simulation device 1 (simulation unit 11 and patch generation unit 12) generates a plurality of patches on the surface to be machined and deletes patches that will be cut off by the tool when the tool machines along the path (see, for example, FIGS. 3A and 3B).

In Step ST106, the simulation device 1 (simulation unit 11 and patch generation unit 12) newly generates a plurality of patches on the remaining surface (machined surface area) of the workpiece (see, for example, FIG. 3C).

Then, in Step ST107, the simulation device 1 (associated information storage unit 22) stores the number of the block that includes the executed (simulated) G-code and the numbers of the newly generated patches in association with each other.

In Step ST108, the simulation device 1 (simulation unit 11) determines whether or not there is a next block to be executed (simulated) with the machining program. If the simulation device 1 determines that there is a next block (YES), processing is returned to before Step ST101. If the simulation device 1 determines that there is no next block (NO), processing is ended.

Next, operation of the simulation device when editing a block in the machining program corresponding to a specific machined surface is described with reference to FIG. 5.

First, in Step ST201, a worker selects a specific portion of an erroneously cut surface (machined surface) on the basis of a model image of the workpiece displayed on the display unit 30 of the simulation device 1. In the simulation device 1, the machined surface selection unit 14 selects patches that correspond to the selected portion on the erroneously cut surface (machined surface).

Then, in Step ST202, the simulation device 1 (machined surface selection unit 14) acquires patch numbers that correspond to the selected portion.

Next, in Step ST203, the simulation device 1 (block identification information acquisition unit 15) acquires a block number that identifies a block (part of a machining program) that is stored in association with the patch numbers from the associated information storage unit 22.

Then, in Step ST204, the simulation device 1 (block identification information acquisition unit 15) acquires program content of the block identified using the block identification information from the machining program storage unit 21.

In Step ST205, the simulation device 1 (display control unit 13) displays a model image of the workpiece W and the program content (including the G-code) of the block identified using the block identification information on the display unit 30.

Then, in Step ST206, the worker examines whether the G-code needs to be edited. If the G-code is to be edited (YES), the simulation device 1 receives edited content from the input unit 40 and edits the machining program (content of the applicable block) using the machining program editing unit 16 and outputs the edited content to the display control unit 13. If the G-code is not to be edited (NO), the processing ends.

Next, in Step ST207, the simulation device 1 (display control unit 13) displays the model image of the workpiece W and the edited program content (including the G-code) on the display unit 30.

Then, in Step ST208, if the simulation device 1 performs simulation again with the edited machining program (YES), processing returns to before Step ST201. If the simulation device 1 does not perform simulation again with the edited machining program (NO), processing ends.

With the simulation device 1 according to this embodiment employing the above-described configuration, a block in a machining program that corresponds to a specific machined surface area can be checked.

The simulation device according to this embodiment includes an associated information storage unit that stores, in association with each other, machined surface identification information that can identify each of plurality of machined surface areas in the machined shape of a workpiece simulated by a simulation unit, and block identification information that can identify blocks in a program that machine each of the plurality of machined surface areas, a machined surface selection unit that can select a specific machined surface area among the plurality of machined surface areas, and a block identification information acquisition unit that acquires from the associated information storage unit, when the specific machined surface area is selected by the machined surface selection unit, the block identification information stored in association with the machined surface identification information that identifies the selected machined surface area. As a result, with the simulation device according to this embodiment, a block (part of a machining program) that machines a machined surface area that has been erroneously cut or the like can be easily checked by selecting the machined surface area.

With the simulation device according to the embodiment, the simulation unit defines a specific machined surface area among a plurality of machined surface areas using a plurality of patches, the associated information storage unit stores patch identification information that identifies the patches that define the specific machined surface area and block identification information on the machining program that machines the portion corresponding to the patches in association with each other, the machined surface selection unit can select the patches as a machined surface area and the block identification information acquisition unit is configured to, when specific patches are selected by the machined surface selection unit, acquire the block identification information stored in association with the patch identification information that identifies the selected patches from the associated information storage unit. As a result, with the simulation device according to this embodiment, a block (part of a machining program) that machines the machined surface containing the patches can be easily checked by selecting the patches generated on the machined surface area that has been erroneously cut. The simulation device according to the embodiment is particularly effective in terms of patch selection when the machined surface is a curved surface.

The simulation device according to the embodiment further includes a machining program storage unit that stores the machining program containing the plurality of blocks; a display control unit that generates a model image of the machined shape of the workpiece including the plurality of machined surface areas simulated by the simulation unit; and a display unit that can display the model image generated by the display control unit, in which the machined surface selection unit is configured to be able to select a specific machined surface area on the basis of the model image displayed on the display unit, the block identification information acquisition unit is able to acquire the block identification information from the associated information storage unit and acquire program content of a block identified using the block identification information from the machining program storage unit, and the display control unit displays on the display unit, when a specific machined surface area is selected by the machined surface selection unit, a model image of the machined shape of the workpiece including the selected machined surface area, and the program content of the block acquired by the block identification information acquisition unit. As a result, with the simulation device according to this embodiment, a block (part of a machining program) that machines a machined surface that has been erroneously cut can be easily checked by selecting the machined surface area. In addition, with the simulation device according to this embodiment, a block (part of a machining program) that machines the machined surface that has been erroneously cut can be easily edited.

An embodiment of the present invention has been described above, but the present invention is not limited to the above-described embodiment. Effects described in the embodiment are merely examples of the most preferable effects obtained by the present invention and effects of the present invention are not limited to those described herein.

### EXPLANATION OF REFERENCE NUMERALS

1 simulation device
10 control unit
11 simulation unit
12 patch generation unit
13 display control unit
14 machined surface selection unit
15 block identification information acquisition unit
16 machining program editing unit
20 storage unit
21 machining program storage unit
22 associated information storage unit
30 display unit
40 input unit
W workpiece
WM model image
K tool

What is claimed is:

1. A simulation device comprising:
a simulation unit that generates a machining path for a tool on the basis of a machining program that specifies information on the shape of a workpiece and information on the shape of a tool, to thereby simulate a machined shape of a workpiece including a plurality of machined surface areas that are machined by the tool;
an associated information storage unit that stores, in association with each other, machined surface identification information that can identify each of the plurality of machined surface areas in the machined shape of the workpiece simulated by the simulation unit, and block identification information that identifies blocks in a program that machine each of the plurality of machined surface areas;
a machined surface selection unit that can select a specific machined surface area among the plurality of machined surface areas; and
a block identification information acquisition unit that acquires from the associated information storage unit, when a specific machined surface area is selected by the machined surface selection unit, the block identification information stored in association with the machined surface identification information that identifies the selected machined surface area.

2. The simulation device according to claim 1, wherein:
the simulation unit defines the specific machined surface area among the plurality of machined surface areas using a plurality of patches;
the associated information storage unit stores, in association with each other, patch identification information that identifies the patches that define the specific machined surface area, and the block identification information on the machining program that machines a portion corresponding to the patches;
the machined surface selection unit can select the patches as the machined surface area; and
the block identification information acquisition unit acquires from the associated information storage unit, when a specific patch is selected by the machined surface selection unit, the block identification information stored in association with the patch identification information that identifies the selected patches.

3. The simulation device according to claim 1, further comprising:
a machining program storage unit that stores the machining program containing the plurality of blocks;
a display control unit that generates a model image of the machined shape of the workpiece including the plurality of machined surface areas simulated by the simulation unit; and
a display unit that can display the model image generated by the display control unit,
the machined surface selection unit being configured to be able to select a specific machined surface area on the basis of the model image displayed on the display unit,
the block identification information acquisition unit being able to acquire the block identification information from the associated information storage unit and acquire program content of a block identified using the block identification information from the machining program storage unit, and
the display control unit displaying on the display unit, when a specific machined surface area is selected by the machined surface selection unit, the model image of the machined shape of the workpiece including the selected machined surface area, and the program content of the block acquired by the block identification information acquisition unit.

4. The simulation device according to claim 2, further comprising:
a machining program storage unit that stores the machining program containing the plurality of blocks;
a display control unit that generates a model image of the machined shape of the workpiece including the plurality of machined surface areas simulated by the simulation unit; and
a display unit that can display the model image generated by the display control unit,
the machined surface selection unit being configured to be able to select a specific machined surface area on the basis of the model image displayed on the display unit,
the block identification information acquisition unit being able to acquire the block identification information from the associated information storage unit and acquire program content of a block identified using the block identification information from the machining program storage unit, and
the display control unit displaying on the display unit, when a specific machined surface area is selected by the machined surface selection unit, the model image of the machined shape of the workpiece including the selected machined surface area, and the program content of the block acquired by the block identification information acquisition unit.
